(19) United States
(12) Patent Application Publication
(10) Pub. No.: US 2018/0176660 A1
(43) Pub. Date: Jun. 21, 2018

(54) SYSTEMS AND METHODS FOR ENHANCING USER EXPERIENCE OF A USER WATCHING VIDEO CONTENT

(71) Applicant: COMIGO LTD., Yarkona (IL)

(72) Inventor: Motty LENTZITZKY, Tel Aviv (IL)

(21) Appl. No.: 15/723,784

(22) Filed: Oct. 3, 2017

Related U.S. Application Data
(60) Provisional application No. 62/434,477, filed on Dec. 15, 2016.

(51) Int. Cl. H04N 21/81; H04N 21/44; H04N 21/439; H04N 21/4722

(52) U.S. Cl. CPC H04N 21/8133; H04N 21/4722; H04N 21/4394; H04N 21/44008

(57) ABSTRACT

Devices, systems, and methods for providing enrichment data relating to an entity included in a video content item, the entity being identified in real time and by open-list identification, and the enrichment data including data having a dynamic connection to the identified entity.

### RELATED APPLICATION

The present application gains priority from U.S. Provisional Patent Application 62/434,477 filed on Dec. 15, 2016 and entitled “Enrichment of Media Content Watching Experience”, which is incorporated herein by reference as if fully set forth herein.

### FIELD AND BACKGROUND OF THE INVENTION

The invention, in some embodiments, relates to displaying of one or more video content items, and more particularly to methods and systems that automatically identify in real-time at least one entity in the video content item and identify enrichment data having connection to the identified entity.

When TV technology first became commercially available to the public, users could only consume video content items in their homes under fixed pre-determined schedules and in a linear way. That is—a user could only watch a movie or a news program at the time a broadcaster decided to broadcast it, and no deviation from the pre-defined program schedule was possible. The only flexibility a user had was the ability to select which channel to display on one's TV screen, thus selecting between multiple video content items that are simultaneously aired or broadcast.

At a later stage, Video-On-Demand (VOD) was offered to the users. This service enabled users to consume content not appearing on the current programs schedule and/or not being aired or broadcast at a specific time convenient for the user, and resulted in a significant increase in flexibility when deciding what to watch and when to watch. Another boost in user flexibility was achieved when TV operators introduced Catch-Up TV services, which not only allow a user to pick any program recently offered in the EPG (Electronic Program Guide), but also allow the user to jump backward and forward in time within a specific program, and to freeze (pause) and resume the playing of a program.

The next step in the process of increasing user flexibility and freedom of choice was reached when some Set-Top Boxes (STBs) started enabling navigation between different media content items. For example, a user currently watching, or who has just finishing watching, a movie relating to a crime mystery in Australia, may ask the TV system to propose another media content item that is related to the movie currently being watched or other information related to that movie, which the user may then choose to watch. The user may then be presented with a list of options, which, for example, may include:
a. One or more other crime mysteries;
b. One or more other movies set in Australia;
c. One or more other movies having the same director as the current movie;
d. One or more other movies whose cast includes an actor or an actress that also appears in the current movie;
e. A review of the current movie by the New York Times;
f. A biography of the main actress of the current movie;
g. A still picture of the main actress of the current movie; and
h. A graphic animation that is based on the plot of the current movie.
   The user may then select an item in the list, and in response will be presented with the selected movie or with the selected information.

Such linking of media content items to other related media content items and/or to other related information brought user flexibility and freedom of choice to new levels not available before.

An additional improvement in user flexibility occurred when STBs started proposing related media content items and related other information that are not necessarily related to the currently played media content item as a whole, but are related to specific portions of a currently playing media content item or are related to specific entities appearing for a short period of time in a currently playing media content item. For example, a short appearance of a certain geographical location (for example the UN building in New York City) in a movie or in a news program may result in offering to the user additional media content items and/or other information items that are related to that location. The user may, for example, be presented with a list of options that may include:
a. One or more movies whose plot, or a part thereof, occurs in the UN building;
b. One or more movies whose plot, or a part thereof, deals with diplomatic relations between states;
c. An article about the history of the UN organization;
d. A biography of the current Secretary General of the UN organization; and
e. A still picture of the first Secretary General of the UN organization.

This linking of entities embedded within media content items to related media content items and/or to other types of related information brought user flexibility and freedom of choice to further new levels not previously available.

However, such systems are based on a predefined list of entities, and do not identify entities not included in the predefined list. Additionally, the linking of the entities to related media content items and/or to other types of related information in such systems is limited to previously-known connections.

There is therefore a need in the art for methods and systems for providing users with enrichment information or other data relating to entities identified based on open-list identification, in real-time.

### SUMMARY OF THE INVENTION

Some embodiments of the invention relate to methods, systems, and devices for enhancing the user experience of a user watching video content item by proposing to the user enrichment data relating to an entity identified in the currently watched video content item.

According to an aspect of a first embodiment of the invention, there is provided a method for enhancing user experience of a user watching video content on a screen of a client terminal, the method including:
a) providing at least a portion of a video content item to the client terminal, thereby enabling playing the at least a portion of the video content item on the screen of the client terminal;
b) during the playing of the at least a portion of the video content item, identifying an entity in the video content item in real-time, wherein the identification is an open-list identification;
c) identifying enrichment data having a connection to the entity;
d) providing the identified enrichment data to the client terminal during the playing of the at least a portion of the video content item by the client terminal, thereby enabling displaying the identified enrichment data on the screen of the client terminal.

In some embodiments, the connection between the enrichment data and between the entity is a dynamic connection.

In some embodiments, the identifying of the entity includes performing a visual analysis of a video channel of the at least a portion of the video content item. In some embodiments, the identifying of the entity includes performing aural analysis of an audio channel of the at least a portion of the video content item.

In some embodiments, the entity has an explicit appearance in the at least a portion of the video content item. In some embodiments, the explicit appearance of the entity is an explicit appearance of a name of the entity in an audio channel of the at least a portion of the video content item. In some embodiments, the explicit appearance of the entity is an explicit appearance of a name of the entity in a video channel of the at least a portion of the video content item.

In some embodiments, the entity lacks an explicit appearance in the at least a portion of the video content item.

In some embodiments, the identifying of the entity includes:
a) identifying multiple entities in the at least a portion of the video content item;
b) finding a common entity that is related to each one of the multiple entities; and
c) selecting the common entity to be the identified entity.

In some embodiments, the method further includes:
e) during the playing of the at least a portion of the video content item by the client terminal, receiving a request from the user to propose enrichment data that is connected to the at least a portion of the video content item;
f) subsequent to the receiving of the request and subsequent to the providing of the identified enrichment data to the client terminal, presenting the user with an option to display the identified enrichment data; and
g) subsequent to the user activating the option, displaying the identified enrichment data on the screen of the client terminal.

In some embodiments, the method further includes:
e) during the playing of the at least a portion of the video content item by the client terminal, presenting the user with an option to display the identified enrichment data; and
f) subsequent to the user activating the option, displaying the identified enrichment data on the screen of the client terminal.

In some embodiments, the method further includes displaying the identified enrichment data during the playing of the at least a portion of the video content item by the client terminal.

In some embodiments, the method further includes displaying the identified enrichment data, wherein for at least one point in time the at least a portion of the video content item and the identified enrichment data are being displayed in parallel.

In some embodiments, the identifying of the enrichment data includes retrieving the enrichment data from the Internet.

In some embodiments, the identifying of the enrichment data includes retrieving the enrichment data from a local storage device located in the vicinity of the client terminal.

In some embodiments, the identifying of the enrichment data is based on a location of the user. In some embodiments, the identifying of the enrichment data is based on a preference of the user. In some embodiments, the identifying of the enrichment data is based on at least one of current time of the day, current day of the week, current day of the month, a gender of the user and an age of the user.

According to an aspect of a second embodiment of the invention, there is provided a method for enhancing user experience of a user watching video content on a screen of a client terminal, the method including:
a. providing at least a portion of a video content item to the client terminal, thereby enabling playing of the at least a portion of the content item on the screen of the client terminal;
b. during the playing of the at least a portion of the video content item, identifying an entity in the video content item in real-time;
c. identifying enrichment data having a connection to the entity, wherein the connection between the enrichment data and between the entity is a dynamic connection; and
d. providing the identified enrichment data to the client terminal during the playing of the at least a portion of the video content item by the client terminal, thereby enabling displaying the identified enrichment data on the screen of the client terminal.

In some embodiments, the identification of the entity is an open-list identification.

In some embodiments, the identified enrichment data is created during the playing of the at least a portion of the video content item by the client terminal.

In some embodiments, the identifying of the enrichment data includes retrieving the enrichment data from the Internet. In some embodiments, the identifying of the enrichment data includes retrieving the enrichment data from a local storage device located in the vicinity of the client terminal.

In some embodiments, the identifying of the enrichment data is based on a location of the user. In some embodiments, the identifying of the enrichment data is based on a preference of the user. In some embodiments, the identifying of the enrichment data is based on at least one of current time of the day, current day of the week, current day of the month, a gender of the user and an age of the user.

In some embodiments, the identifying of the entity includes performing a visual analysis of a video channel of the at least a portion of the video content item. In some embodiments, the identifying of the entity includes performing aural analysis of an audio channel of the at least a portion of the video content item.

In some embodiments, the entity has an explicit appearance in the at least a portion of the video content item. In some embodiments, the explicit appearance of the entity is an explicit appearance of a name of the entity in an audio channel of the at least a portion of the video content item. In some embodiments, the explicit appearance of the entity is an explicit appearance of a name of the entity in a video channel of the at least a portion of the video content item.

In some embodiments, the entity lacks an explicit appearance in the video content item.

In some embodiments, the identifying of the entity includes:
a) identifying multiple entities in the at least a portion of the video content item;
b) finding a common entity that is related to each one of the multiple entities; and
c) selecting the common entity to be the identified entity.

In some embodiments, the method further includes:
e) during the playing of the at least a portion of the video content item by the client terminal, receiving a request from the user to propose enrichment data that is connected to the at least a portion of the video content item;
f) subsequent to the receiving of the request and subsequent to the providing of the identified enrichment data to the client terminal, presenting the user with an option to display the identified enrichment data; and
g) subsequent to the user activating the option, displaying the identified enrichment data on the screen of the client terminal.

In some embodiments, the method further includes:
e) during the playing of the at least a portion of the video content item by the client terminal, presenting the user with an option to display the identified enrichment data; and
f) subsequent to the user activating the option, displaying the identified enrichment data on the screen of the client terminal.

In some embodiments, the method further includes displaying the identified enrichment data during the playing of the at least a portion of the video content item by the client terminal.

In some embodiments, the method further includes displaying the identified enrichment data, wherein for at least one point in time the at least a portion of the video content item and the identified enrichment data are being displayed in parallel.

According to another aspect of the first embodiment of the invention, there is provided a device for enhancing user experience of a user watching video content on a screen of a client terminal, the device including:
a) a processor in communication with the client terminal; and
b) a non-transitory computer readable storage medium for instructions execution by the processor, the non-transitory computer readable storage medium having stored:
   i) instructions to provide at least a portion of a video content item to the client terminal, thereby to enable playing the at least a portion of the video content item on the screen of the client terminal;
   ii) instructions, to be carried out during the playing of the at least a portion of the video content item, to identify an entity in the video content item in real-time, wherein the identification is an open-list identification;
   iii) instructions to identify enrichment data having a connection to the entity; and
   iv) instructions to provide the identified enrichment data to the client terminal during the playing of the at least a portion of the video content item by the client terminal, thereby to enable displaying the identified enrichment data on the screen of the client terminal.

In some embodiments, the connection between the enrichment data and between the entity is a dynamic connection.

In some embodiments, the instructions to identify the entity include instructions to perform a visual analysis of a video channel of the at least a portion of the video content item. In some embodiments, the instructions to identify the entity include instructions to perform aural analysis of an audio channel of the at least a portion of the video content item.

In some embodiments, the entity has an explicit appearance in the at least a portion of the video content item. In some embodiments, the explicit appearance of the entity is an explicit appearance of a name of the entity in an audio channel of the at least a portion of the video content item. In some embodiments, the explicit appearance of the entity is an explicit appearance of a name of the entity in a video channel of the at least a portion of the video content item.

In some embodiments, the entity lacks an explicit appearance in the at least a portion of the video content item.

In some embodiments, the instructions to identify the entity include:
a) instructions to identify multiple entities in the at least a portion of the video content item;
b) instructions to find a common entity that is related to each one of the multiple entities; and
c) instructions to select the common entity to be the identified entity.

In some embodiments, the instructions to identify the enrichment data include instructions to retrieve the enrichment data from the Internet. In some embodiments, the instructions to identify the enrichment data include instructions to retrieve the enrichment data from a local storage device located in the vicinity of the client terminal.

In some embodiments, the instructions to identify the enrichment data are based on a location of the user. In some embodiments, the instructions to identify the enrichment data are based on a preference of the user. In some embodiments, the instructions to identify the enrichment data are based on at least one of current time of the day, current day of the week, current day of the month, a gender of the user and an age of the user.

In some embodiments, there is provided a system for enhancing user experience of a user watching video content on a screen of a client terminal, the system including:
a) a central server including the device according to the first embodiment herein; and
b) the client terminal having the screen associated therewith, the client terminal including:
   i) a second processor in communication with the central server; and
   ii) a second non-transitory computer readable storage medium for instructions execution by the second processor, the second non-transitory computer readable storage medium having stored:
      a. instructions, to be carried out during the playing of the at least a portion of the video content item by the client terminal, to receive a request from the user to propose enrichment data that is connected to the at least a portion of the video content item;
      b. instructions, to be carried out subsequent to carrying out of the instructions to receive the request and subsequent to carrying out of the instructions to provide the identified enrichment data to the client terminal, to present the user with an option to display the identified enrichment data; and
      c. instructions, to be carried out subsequent to the user activating the option, to display the identified enrichment data on the screen of the client terminal.

In some embodiments, there is provided a system for enhancing user experience of a user watching video content on a screen of a client terminal, the system including:
a) a central server including the device according to the first embodiment herein; and
b) the client terminal having the screen associated therewith, the client terminal including:
   i) a second processor in communication with the central server; and
   ii) a second non-transitory computer readable storage medium for instructions execution by the second processor, the second non-transitory computer readable storage medium having stored:
      a. instructions, to be carried out during the playing of the at least a portion of the video content item by the client terminal, to present the user with an option to display the identified enrichment data; and
      b. instructions, to be carried out subsequent to the user activating the option, to display the identified enrichment data on the screen of the client terminal.

In some embodiments, there is provided a system for enhancing user experience of a user watching video content on a screen of a client terminal, the system including:
a) a central server including the device according the first embodiment described herein; and
b) the client terminal having the screen associated therewith, the client terminal including:
   i) a second processor in communication with the central server; and
   ii) a second non-transitory computer readable storage medium for instructions execution by the second processor, the second non-transitory computer readable storage medium having stored instructions to display the identified enrichment data on the screen of the client terminal during the playing of the at least a portion of the video content item by the client terminal.

In some embodiments, there is provided a system for enhancing user experience of a user watching video content on a screen of a client terminal, the system including:
a) a central server including the device according the first embodiment described herein; and
b) the client terminal having the screen associated therewith, the client terminal including:
   i) a second processor in communication with the central server; and
   ii) a second non-transitory computer readable storage medium for instructions execution by the second processor, the second non-transitory computer readable storage medium having stored instructions to display the identified enrichment data on the screen of the client terminal, wherein for at least one point in time the at least a portion of the video content item and the identified enrichment data are being displayed in parallel.

According to another aspect of the second embodiment of the invention, there is provided a device for enhancing user experience of a user watching video content on a screen of a client terminal, the device including:
a. a processor in communication with the client terminal; and
b. a non-transitory computer readable storage medium for instructions execution by the processor, the non-transitory computer readable storage medium having stored:
   i. instructions to provide at least a portion of a video content item to the client terminal, thereby to enable playing the at least a portion of the video content item on the screen of the client terminal;
   ii. instructions, to be carried out during the playing of the at least a portion of the video content item, to identify an entity in the video content item in real-time;
   iii. instructions to identify enrichment data having a connection to the entity, wherein the connection between the enrichment data and between the entity is a dynamic connection; and
   iv. instructions to provide the identified enrichment data to the client terminal during the playing of the at least a portion of the video content item by the client terminal, thereby to enable displaying the identified enrichment data on the screen of the client terminal.

In some embodiments, the identification of the entity is an open-list identification.

In some embodiments, the identified enrichment data is created during the playing of the at least a portion of the video content item by the client terminal.

In some embodiments, the instructions to identify the enrichment data include instructions to retrieve the enrichment data from the Internet. In some embodiments, the instructions to identify the enrichment data include instructions to retrieve the enrichment data from a local storage device located in the vicinity of the client terminal.

In some embodiments, the instructions to identify the enrichment data are based on a location of the user. In some embodiments, the instructions to identify the enrichment data are based on a preference of the user. In some embodiments, the instructions to identify the enrichment data are based on at least one of current time of the day, current day of the week, current day of the month, a gender of the user and an age of the user.

In some embodiments, the instructions to identify the entity include instructions to perform a visual analysis of a video channel of the at least a portion of the video content item. In some embodiments, the instructions to identify the entity include instructions to perform aural analysis of an audio channel of the at least a portion of the video content item.

In some embodiments, the entity has an explicit appearance in the at least a portion of the video content item. In some embodiments, the explicit appearance of the entity is an explicit appearance of a name of the entity in an audio channel of the at least a portion of the video content item. In some embodiments, the explicit appearance of the entity is an explicit appearance of a name of the entity in a video channel of the at least a portion of the video content item.

In some embodiments, the entity lacks an explicit appearance in the at least a portion of the video content item.

In some embodiments, the instructions to identify the entity include:
a) instructions to identify multiple entities in the at least a portion of the video content item;
b) instructions to find a common entity that is related to each one of the multiple entities; and
c) instructions to select the common entity to be the identified entity.

In some embodiments, there is provided a system for enhancing user experience of a user watching video content on a screen of a client terminal, the system including:
a. a central server including the device according to the second embodiment herein; and
b. the client terminal having the screen associated therewith, the client terminal including:
   i. a second processor in communication with the central server; and
   ii. a second non-transitory computer readable storage medium for instructions execution by the second processor, the second non-transitory computer readable storage medium having stored:
      1. instructions, to be carried out during the playing of the at least a portion of the video content item by the client terminal, to receive a request from the user to propose enrichment data that is connected to the at least a portion of the video content item;
      2. instructions, to be carried out subsequent to carrying out of the instructions to receive the request and subsequent to carrying out of the instructions to provide the identified enrichment data to the client terminal, to present the user with an option to display the identified enrichment data; and
      3. instructions, to be carried out subsequent to the user activating the option, to display the identified enrichment data on the screen of the client terminal.

In some embodiments, there is provided a system for enhancing user experience of a user watching video content on a screen of a client terminal, the system including:
a. a central server including the device according to the second embodiment herein; and
b. the client terminal having the screen associated therewith, the client terminal including:
   i. a second processor in communication with the central server; and
   ii. a second non-transitory computer readable storage medium for instructions execution by the second processor, the second non-transitory computer readable storage medium having stored:
      1. instructions, to be carried out during the playing of the at least a portion of the video content item by the client terminal, to present the user with an option to display the identified enrichment data; and
      2. instructions, to be carried out subsequent to the user activating the option, to display the identified enrichment data on the screen of the client terminal.

In some embodiments, there is provided a system for enhancing user experience of a user watching video content on a screen of a client terminal, the system including:
a. a central server including the device according to the second embodiment herein; and
b. the client terminal having the screen associated therewith, the client terminal including:
   i. a second processor in communication with the central server; and
   ii. a second non-transitory computer readable storage medium for instructions execution by the second processor, the second non-transitory computer readable storage medium having stored instructions to display the identified enrichment data on the screen of the client terminal during the playing of the at least a portion of the video content item by the client terminal.

In some embodiments, there is provided a system for enhancing user experience of a user watching video content on a screen of a client terminal, the system including:
a. a central server including the device according to the second embodiment herein; and
b. the client terminal having the screen associated therewith, the client terminal including:
   i. a second processor in communication with the central server; and
   ii. a second non-transitory computer readable storage medium for instructions execution by the second processor, the second non-transitory computer readable storage medium having stored instructions to display the identified enrichment data on the screen of the client terminal, wherein for at least one point in time the at least a portion of the video content item and the identified enrichment data are being displayed in parallel.

Unless otherwise defined, all technical and scientific terms used herein have the same meaning as commonly understood by one of ordinary skill in the art to which the invention pertains. In case of conflict, the specification, including definitions, will take precedence.

As used herein, the terms “comprising”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

### BRIEF DESCRIPTION OF THE FIGURES

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are used to designate like elements.

In the drawings:

FIGS. 1A and 1B are, respectively, a schematic block diagram of an embodiment of a system for enhancing user experience of a user watching video content and a flow chart of a method for enhancing user experience of a user watching video content, according to a first embodiment of the teachings herein;

FIGS. 2A and 2B are, respectively, a schematic block diagram of an embodiment of a system for enhancing user experience of a user watching video content and a flow chart of a method for enhancing user experience of a user watching video content, according to a second embodiment of the teachings herein; and

FIGS. 3A to 3E are schematic representations of implementation of various steps of the method of FIG. 1B using the system of FIG. 1A, that are also partially applicable for the method of FIG. 2B using the system of FIG. 2A.

### DESCRIPTION OF SOME EMBODIMENTS OF THE INVENTION

The invention, in some embodiments, relates to displaying of one or more video content items, and more particularly to methods and systems that automatically identify in real-time at least one entity in the video content item and identify enrichment data having connection to the identified entity.

As mentioned hereinabove, in spite of the significant improvements achieved so far in increasing user flexibility and freedom of choice, prior art TV systems still do not provide satisfactory solutions for many real-world scenarios in which it is desired to enrich the media content watching experience by providing the user with options for selecting media content items and/or other information items that are related to entities appearing in a currently playing media content item.

For instance, the above example of the UN building briefly appearing within a movie or a news program faithfully represents the limitations of prior art TV systems by having the following characteristics:
A. The processing involved in selecting what optional additional content to propose to the user as “related content” includes a step of answering the question “related to what?”. This step requires identifying the entity to which the proposed media content or other data should be related. This step is typically achieved by a visual analysis of a video track, an aural analysis of an audio track, or a textual analysis of metadata associated with the currently playing media content item. In prior art TV systems the real-time identification of an entity in a media content item is limited to closed-list identification. This means that there exists a pre-defined list of entities which defines the potential space of identifiable entities, and for any entity to be identified within the media content item, it must appear (in advance of the identification) in such a list. This characteristic is a result of methods currently employed in implementing real-time entity identification in media content items:
   a. One common method (see for example US Application 2012/0183229 to McDevitt entitled “System and Method for Recognition of Items in Media Data and Delivery of Information Related Thereto”, which is incorporated herein by reference in its entirety) is to identify entities by matching their visual appearance against a database of known visual appearances of potential entities. For example, a system may identify an actor in a movie by extracting an image of his face from the visual track of the movie and matching it against a database of images of faces of actors.
   b. Another common method (see for example paragraph [0034] of the McDevitt US application mentioned above) is to identify entities by matching audio clips from the media content item against a database of known audio clips. For example, a system may identify a singer appearing in a movie by extracting a portion of a song from the audio track and matching it against a database of known songs of known singers.
   c. Yet another common method (see for example US Application 2016/0127759 to Jung et al. entitled “Terminal Device and Information Providing Method Thereof”, which is incorporated herein by reference in its entirety) is to identify entities by matching signatures calculated for frames of the video track against a database of known signatures. For example, a system may identify, as an entity, a geographic location appearing in a movie by calculating a signature of the first frame in which that geographic location is shown and matching it against a database of signatures of frames of media content items. When a match is found, the system knows the name and other information relating to the geographic location, and also knows that the location had just started to be visible to the user. Note that this method (unlike the previous ones) requires an additional step of pre-processing of the currently playing media content item (before it is played) in order to generate the signatures corresponding to the frames of the media content item and to add them to the signatures database.
   d. Another common method (see for example US Application 2016/0119691 to Accardo et al. entitled “Descriptive Metadata Extraction and Linkage with Editorial Content”, which is incorporated herein by reference in its entirety) is to identify entities by inserting watermarks into the audio or video tracks of the currently playing media content item and matching them against a watermarks database. For example, a system may identify a geographic location appearing in a movie by inserting a unique watermark in or near the first frame in which that location is shown and then detecting when that watermark is reached. When that happens, the detected watermark is matched against the watermarks database, thus letting the system know the geographic location had just started to be visible to the user. Note that this method (like the previous one) requires an additional step of pre-processing of the currently playing media content item (before it is played) in order to insert the watermarks.
All the above methods for real-time entity identification in media content items require the existence of some pre-defined closed list of candidates, such that the system can only pick a detected entity from this closed list. In the exemplary prior art methods discussed above, the pre-defined list is explicitly or implicitly defined by the database used, which may be an images database, an audio clips database, a signatures database, a watermarks database, and the like.
B. Once an entity is identified, the processing involved in selecting what options to propose to the user as “related content” includes a step of locating related media content items and/or other related information items that are connected in some way to the identified entity. In prior art TV systems, such locating of related content/information is limited to static connections that are already known to the system at the time the media content item begins playing. This characteristic is again a result of the methods currently employed in implementing entity identification, which were explained hereinabove. As the prior art systems pick their identified entities from pre-defined closed lists of entities, they also use those pre-defined lists or database records for linking the entities with pre-defined connections to corresponding related content/information. If, for example, the identified entity is a movie actor, then that actor has an entry in the pre-defined database (in which it was found). That entry may also store pre-defined connections to related media content items and/or to other related information items such as a picture of his spouse, a biography, a list of all his movies, video clips from some of his other movies, etc. Whenever this actor is identified in a movie, for any user and for any movie, the same potential connections will be considered. Obviously the actual list of options presented to a user will not necessarily be the same for all users, as the system may adjust the proposed list according to the current circumstances (for example removing options that refer to the movie currently being played or removing options the current user had recently watched), but in all cases the connections proposed to the user are static connections that were prepared in advance by the TV operator or by the content provider and were stored for later use when users ask for proposals of content items.

The above characteristics that are common to all prior art TV systems result in unsatisfactory operation in some common scenarios.

To demonstrate the problem caused by the first characteristic of the prior art TV systems described above, consider the following first example. A user is watching a news program. One of the news items is about a bank robbery that had just occurred in San Francisco. The audio track mentions there is an increase in crime rate in San Francisco. If the user now asks for related content/information, he may be happy to receive, among other things, information about the crime rate in his own area and maybe also in some other nearby areas, so he can get a feeling for the severity of crime in his neighborhood. However, in prior art TV systems it is highly unlikely that the term “crime rate” will be identified as an entity to which connections to related content/information should be proposed. This is because it is highly unlikely that an abstract term like “crime rate” will be included in the pre-defined closed-list of potential entities used by the system. Such identification of the term “crime-rate” is even more unlikely when the current video content item is a real-time live video content item, as many news items are, for which no pre-defined tags, keywords or lists could be prepared in advance. Therefore, prior art TV systems are not able to satisfy the user's expectations in this scenario.

To demonstrate the problem caused by the second characteristic of the prior art TV systems described above, consider the following second example. A user is watching a news program. One of the news items is about a major car accident occurring in one of the tunnels in New York City. If the user now asks for related content/information, he may be happy to get (among other things) information about all the cases of car accidents that had occurred in his area, and maybe also in some other nearby areas, during the last hour. Even if the system correctly identifies that the entity of interest to the user is car accidents, it is highly unlikely that prior art systems will propose the right links to such recent news items because all their connections to the entity are static and cannot point to content/information that did not even exist at the time that the currently playing news program began playing. Therefore prior art TV systems are not able to satisfy the user's expectations in this scenario.

In addition to the limitations discussed above, there is also the issue of how the proposal of related content to the user is initiated. In the prior art systems, even though all recommendations are based on static and pre-defined connections, the user is required to explicitly ask for the proposed related content items. Many users do not take advantage of these capabilities because their mode of watching TV content is mostly passive. Even if they are aware of the “related content” options of their TV system, they will typically not use them.

Additionally, even if the capability of proposing content related to a brief segment within a longer content item would be available, in many cases (as for example in the United Nations building example above) users may not be quick enough to respond during the short interval in which their item of interest (the UN building in this example) is the topic of discussion or viewing, and by the time they ask for related content the UN building might not be visible anymore and the request will be interpreted as referring to something else.

As explained in detail hereinbelow, the present application provides solutions to these problems by enabling open-list identification of entities, by enabling real-time identification of enrichment data having a connection to an identified entity, thereby allowing for dynamic connections, and by proposing enrichment data to the user even without the user explicitly requesting such enrichment data.

In the context of the present application, the term “media content item” relates to a standalone unit of media content that can be referred to and identified by a single reference, and can be displayed independently of other content. Examples of media content items include a movie, a TV program, an episode of a TV series, a video clip, an animation, an audio clip, or a still image.

In the context of the present application, the term “audio content item” relates to a media content item that contains only an audio track hearable using a speaker or a microphone.

In the context of the present application, the term “video content item” relates to a media content item that contains a visual track viewable on a screen. A video content item may or may not additionally contain an audio track.

In the context of the present application, the terms “audio” and “aural” are used interchangeably.

In the context of the present application, the terms “video” and “visual” are used interchangeably.

In the context of the present application, the terms “audio channel” and “audio track” are used interchangeably, and refer to an audio component of a media content item.

In the context of the present application, the terms “video channel” and “video track” are used interchangeably, and refer to a video component of a media content item. A still image is a special case of video track.

In the context of the present application, the term “media playing device” relates to a device that is capable of playing a media content item. Examples of media playing devices include an audio-only player that is capable of playing an audio content item, a video-only player that is capable of playing a video content item, and a combined video/audio player that is capable of playing both the video channel and the audio channel of a media content item in parallel.

In the context of the present application, the term “displaying a media content item” relates to outputting at least one of a video channel and an audio channel of the media content item through a visual output device (for example a TV screen) or an audio output device (for example a speaker or headphones). If the media content item is a still image, then displaying it means displaying the still image on a visual output device.

In the context of the present application, the term “playing a video content item” relates to outputting a video channel of the video content item through a visual output device (for example a TV screen), and, if available, outputting an audio channel of the video content item through an audio output device (for example a speaker or headphones).

In the context of the present application, the term “entity” relates to something that exists as itself, as a subject or as an object, actually or potentially, concretely or abstractly, physically or not. It need not be of material existence. In particular, abstractions and legal fictions are regarded as entities. There is also no presumption that an entity is animate, or present. Specifically, an entity may be a person entity, a location entity, an organization entity, a topic entity or a group entity.

In the context of the present application, the term “person entity” relates to a real person entity, a character entity or a role entity.

In the context of the present application, the term “real person entity” relates to a person that currently lives or that had lived in the past, identified by a name (e.g. John Kennedy) or a nickname (e.g. Fat Joe, Babe Ruth).

In the context of the present application, the term “character entity” relates to a fictional person that is not alive today and was not alive in the past, identified by a name or a nickname. For example, “Superman”, “Howard Roark”, etc.

In the context of the present application, the term “role entity” relates to a person uniquely identified by a title or by a characteristic. For example “the 23^{rd} president of the United States”. “the oldest person alive today”, “the tallest person that ever lived”, “the discoverer of the penicillin”, etc.

In the context of the present application, the term “location entity” relates to an explicit location entity or an implicit location entity.

In the context of the present application, the term “explicit location entity” relates to a location identified by a name (e.g. “Jerusalem”, “Manhattan 6^{th} Avenue”, “Washington Monument”, “the Dead Sea”) or by a geographic locator (e.g. “ten kilometers north of Golani Junction”, “100 degrees East, 50 degrees North”).

In the context of the present application, the term “implicit location entity” relates to a location identified by a title or a by a characteristic (e.g. “the tallest mountain peak in Italy”, “the largest lake in the world”).

In the context of the present application, the term “organization entity” relates to an organization identified by a name (e.g. “the United Nations”, “Microsoft”) or a nickname (e.g. “the Mossad”).

In the context of the present application, the term “topic entity” relates to a potential subject of a conversation or a discussion. For example, the probability that Hillary Clinton will win the presidential election, the current relations between Russia and the US, the future of agriculture in OECD countries, the crime rate in New York City.

In the context of the present application, the term “group entity” relates to a group of entities of any type. The different member entities of a group may be of different types.

In the context of the present application, the term “nickname of an entity” relates to any name by which an entity is known which is not its official name, including a pen name, a stage name and a name used by the public or by a group of people to refer to it or to address it.

In the context of the present application, the term “enrichment data of an entity” relates to factual data of an entity, buzz data of an entity or relevant data of an entity. Enrichment data of an entity is said to be connected to the entity or related to the entity. Note that “connected to the entity”, “related to the entity”, “having a connection to the entity” and “having a relation to the entity” are all used interchangeably herein.

In the context of the present application, the term “factual data of an entity” relates to any facts about the entity. For example, the age of an actress entity, the name of the spouse of a person entity, the list of movies of an actor entity, the population size of a city entity, the name of the secretary of the United Nations entity, the number of members in the group entity including all past presidents of the US, etc. Factual data of an entity may be provided in the form of text, graphics, image, video clip or audio clip.

In the context of the present application, the term “buzz data of an entity” relates to any information extracted from a social network that has some relation to the entity, regardless if it is factual data of the entity or not. For example, text of a tweet published in Twitter by a person entity, list of people who liked a post by a person entity, a grade given by a person entity to a movie, etc. Buzz data of an entity may be provided in the form of text, graphics, image, video clip or audio clip.

In the context of the present application, the term “relevant data of an entity” relates to any data having some connection to the entity, that is not factual data of the entity and that is not buzz data of the entity. For example, sociological profile of a town in which a person entity lives, an event that occurred in a school in which a person entity studied, etc. Relevant data of an entity may be provided in the form of text, graphics, image, video clip or audio clip.

In the context of the present application, the term “identifying an entity in a media content item” relates to identifying an entity visually appearing in the visual channel of the media content item or identifying an entity mentioned in the audio channel of a media content item. The identification relies on at least one of visual analysis and audio analysis of the content of the media content item. Finding an entity that appears in a media content item by relying only on metadata of the media content item is not considered to be an identification of the entity in the media content item.

In the context of the present application, the term “identifying an entity in a media content item in real-time” relates to a special case of identifying an entity in a media content item in which the identification of the entity is performed while the media content item is being played to a user.

In the context of the present application, the term “closed-list identification of an entity in a media content item” relates to an identification of an entity in a media content item in which the identified entity is a member of a pre-defined list of entities which is already known to the identifying system at the time of starting playing the media content item. Note that an entity identification process may identify both entities that are members of a pre-defined list and entities that are not. Whether a specific identified entity is identified by a closed-list identification or not is determined by whether that specific identified entity is a member of the pre-defined list or not.

In the context of the present application, the term “open-list identification of an entity in a media content item” relates to an identification of an entity in a media content item in which the identified entity is not a member of a pre-defined list of entities which is already known to the identifying system at the time of starting playing the media content item. Note that an entity identification process may identify both entities that are members of a pre-defined list and entities that are not. Whether a specific identified entity is identified by an open-list identification or not is determined by whether that specific identified entity is a member of the pre-defined list or not.

In the context of the present application, the term “static connection between an entity identified in a media content item and between enrichment data of that entity” relates to a connection between the entity and between enrichment data of that entity that is already known to the system at the time of starting the playing of the media content item in which the entity is identified. A connection between an entity and between a link to enrichment data of that entity, where the connection to the link is already known to the system at the time of starting playing the media content item is a static connection even if the content of the enrichment data pointed to by the link is not yet known at the time of starting playing the media content item. For example a connection between a sport event entity and a pre-defined URL to its “current game statistics” website is a static connection even though the game statistics change during the game. Similarly, a connection between an actor entity and a pre-defined link to his Twitter account is a static connection even though the list of tweets may change while the media content item in which the actor appears is playing.

In the context of the present application, the term “dynamic connection between an entity identified in a media content item and between enrichment data of that entity” relates to a connection between the entity and between enrichment data of that entity that is not yet known to the system at the time of starting the playing of the media content item in which the entity is identified. (See the note about a pre-defined link to non-pre-defined enrichment data in the definition of a static connection).

In the context of the present application, the term “or” is used as an “inclusive or”, such that the phrase “A or B” is satisfied by “only A”, “only B”, or “A and B”.

The principles, uses and implementations of the teachings herein may be better understood with reference to the accompanying description and figures. Upon perusal of the description and figures present herein, one skilled in the art is able to implement the invention without undue effort or experimentation.

Before explaining at least one embodiment of the invention in detail, it is to be understood that the invention is not limited in its applications to the details of construction and the arrangement of the components and/or methods set forth in the following description and/or illustrated in the drawings and/or the examples. The invention can be implemented with other embodiments and can be practiced or carried out in various ways.

The present invention provides a solution to the limitations described above, by introducing (i) real-time open-list identification of entities in media content items and (ii) selection of dynamic connections between entities identified in a media content item and between enrichment data corresponding to those entities. Both issues enhance the usefulness of the prior art “related content” functionality offered to TV system users.

In the proposed system, when a user watches a video content item on his TV screen (or on any other screen he may be using for consuming his video content, for example a laptop, a tablet or a smartphone) the local Set-Top Box (or the smart TV, if one is used) is continuously monitoring the content being played. Throughout the playing of the current video content item on the media playing device, the system is analyzing the video channel and the audio channel in real-time in order to extract information about the instantaneous content and to identify entities shown or mentioned in the content. The analysis may include visual analysis and extraction of entities from the visual channel (methods for which are already well known in the prior art), and aural analysis and extraction of entities from the audio channel (methods for which are also already well known in the prior art). Unlike prior art TV systems which also identify entities in a playing video content item, the proposed system is not limited only to closed-list identification of entities in the video content item. In other words, there is no mandatory requirement that an identified entity should be listed in advance in a pre-defined list or in a pre-defined database.

Methods for analyzing a visual channel and/or an audio channel of a media content item are well known in the art. Various aspects of such methods appear, for example, in U.S. Pat. No. 9,077,956 to Morgan et al. titled “Scene identification”, in U.S. Pat. No. 9,141,860 to Vunic et al. titled “Method and system for segmenting and transmitting on-demand live-action video in real-time”, and in the paper “Content-based movie analysis and indexing based on audio visual cues” to Li et al., IEEE Transaction on circuits and systems for video technology volume 14 No. 8 page 1073 (http://mcl.usc.edu/wp-content/uploads/2014/01/200408-Content-based-movie-analysis-and-indexing-based-on-audiovisual-cues.pdf). All of the above patents and papers are incorporated herein by reference in their entirety.

Returning to one of the examples mentioned above—a news items about a bank robbery that had just occurred in San Francisco, where the accompanying audio track mentions there is an increase in crime rate in San Francisco. Real-time aural analysis of the audio track reveals that the term “crime rate” was heard by the user, and then “crime rate” is identified as an entity appearing in the currently playing video content item. This is achieved without referring to any pre-defined list of pre-approved entities that contains the term “crime rate”. In this example, the explicit occurrence of the term in the audio track enables the system to identify it as an entity without relying on any previous information.

Open-list identification of entities in a media content item is not limited to detection of an entity in an audio channel. For example, a video channel may contain a visual image of a name of an entity that can be directly extracted from the image. In a panel of experts sitting in a talk show it is common to have name signs in front of the participants and those names can easily be read by visual analysis.

Additionally, open-list identification of entities in a media content item is not limited to explicit appearance of the entity in the media content item. For example, a sport news program may present several short video clips about several basketball players, all of which currently play in the Golden State Warriors NBA team. The terms “NBA” and “Golden State Warriors” are not mentioned or shown in the clips, neither in the audio channel nor in the video channel. However, the system may identify each of the players, which may be done by closed-list identification, for example by matching images of the players against a database of known images, by open-list identification, for example by visually identifying players' names printed on their shirts, or by a combination of the two, for example some players identified by closed-list identification and other players identified by open-list identification. The system then generalizes from the individual players entities to the higher level entity of the Golden State Warriors team as a whole. Such generalization is achieved by recognizing the connections and/or commonality between the identified individual players and moving up the semantic ladder to the broader team entity, as is well known in the prior art methods of artificial intelligence. In other words, the identification of an entity in a media content item may comprise an identification of multiple entities in the media content item, finding an entity that is somehow related to each of the multiple entities (e.g. a group entity containing as members individual players entities), and then setting that entity to be the identified entity. Such process allows the system to identify the entity “Golden State Warriors” even if such entity is not listed in any pre-defined list of entities or database of entities accessed by the system during the entity identification process and even if such entity does not explicitly appear in the media content item.

Once an entity is identified, the system looks for content items (both media content items such as movies and news items or other types of items such as textual reviews) that are considered enrichment data for the identified entity because they are related to it in some way. In many cases the search is Internet-focused—looking into Twitter accounts, Facebook accounts, archives of news agencies, Wikipedia entries, the IMDb movies database website, etc. However, the search for enrichment data may also refer to locally-stored information, for example by looking for connections to the identified entity in files stored in the local file system of the local STB or the local smart TV, which may include, for example, local copies of movies and still pictures.

Searching for and downloading of enrichment data for a new entity just identified by a real-time analysis of the currently playing content is carried out while the currently playing media content item continues to play. Both the list of enrichment data items from which the user may select and the enrichment data item actually selected by the user, may be shown to the user concurrently with the currently playing media content item, in which the entity to which the enrichment data is related was identified. The list of selectable enrichment data items may include any one or more of video content items, audio content items, textual content, still images, etc.

Unlike prior art TV systems which provide only enrichment data having a static connection to the identified entity, the proposed system is not thus limited and may also provide enrichment data that have dynamic connection to the identified entity.

Looking at the above “crime rate” example, the system may conduct an open-ended Internet search (e.g. using the Google search engine, the Bing search engine, or any other search engine) with “crime rate” as the search term. News items related to “crime rate” that are retrieved by the search may then be proposed to the user as “related content”. Such proposed news items may be dynamic—the connections to them may not be known to the system at the time that the news item containing the identified entity started playing, and even not known to the system when starting the search. Actually, some of the proposed news items may not even exist at the time the media content item started playing.

In one improved embodiment the search term is not simply the term identified by the aural analysis of the audio channel or by the visual analysis of the video channel, but rather a fine-tuned version of the identified term. For example, if the identified entity is “crime rate”, the system may search for a combination of that term with the name of the city in which the user is located. That is—for a user located in New York the system will search for “New York crime rate”, while for a user located in Los Angeles the system will search for “Los Angeles crime rate”.

Other ways of customizing the search term to the interests of a specific user are also possible. For example, the identified entity name may be combined with user-specific information related to known preferences of the user, which is retrieved from a pre-defined user profile. For example, a user may specify a preference for video content over other types of content, and for such user the system may search for “crime rate video” and thus retrieve only (or mainly) video content items related to crime rate. As another example, a user may specify a preference for global news over local news, and for such user the system may search for “US crime rate” instead of “New-York crime rate”. In other examples the identified entity name may be manipulated according to other factors—time of day, day of week, day of month, gender of user, age of user, etc. For example, during weekends the search term may be set to “crime rate movie” while at other times it may be set to “crime rate clip”, thus proposing long video content items when users are expected to have a lot of free time and proposing short video content items when users are expected to be short in time. The more sophisticated the search term manipulation and fine-tuning is, the more likely it becomes for at least some of the retrieved enrichment data to have dynamic connections to the identified entity.

Looking now at another example mentioned above dealing with a car accident entity, the system will conduct an open-ended Internet search (e.g. using Google search engine, the Bing search engine, or any other search engine) with “car accident” as the search term. News items related to that term that are retrieved by the search may then be proposed to the user as related enrichment data. It is highly likely that some of the proposed news items will be dynamic—their connection to the identified entity may not be known to the system at the time the media content item containing the identified entity started playing, and even not known to the system when starting the search. This is so because some of the retrieved news items may deal with car accidents occurring very recently, even later than the time of starting playing the media content item. Here too the search term may be further fine-tuned and customized according to user location, according to user preferences and/or according to other factors (e.g. time, gender, age, etc.), thereby further increasing the likelihood of obtaining related items that are dynamic, which is beyond the ability of the prior art TV systems.

It should be noted that the identification of entities in a media content item may be further enhanced by analysis of metadata associated with the video content (if such exists), such as actor names, director name, year of production, etc. However, finding entities in a media content item based solely on metadata of the media content item is by definition not considered to be identification of entities in a media content item (see the relevant definitions hereinabove). Therefore, the use of metadata is only considered here as auxiliary means for entity identification achieved by visual or aural analysis.

For all of the above embodiments and examples, the proposed enrichment data may be provided in one of the following ways:
A. Recommendations for related content are only proposed to the user after a user explicitly requests them. This is not different from prior art methods, in which the user pushes a button in his remote controller (or employs some other input mechanism) for telling the TV system he is currently interested in proposals for related content. However, unlike in the prior art methods in which the system is able to provide only closed-list entity identification and static connections to enrichment data, the present system also makes open-list entity identifications and recommends content items whose relation to the currently playing media content is dynamic, as in the above examples.
   The playing media content item is analyzed not only with respect to the media content item as a whole, but also with respect to the instantaneous content shown at the time of the user request, even if it is not about the same topic as the surrounding content item. Thus, if the United Nation (UN) building is briefly visible during a news item about New York City, and if the user's request is made during that brief interval in which the UN building is visible, then the list of proposed related items includes both items related to New York City and items related to the United Nations.
B. Recommendations for related content are proposed even without an explicit user request, for example by displaying a list of proposed related items immediately after identifying an entity. The list may be displayed side-by-side with the playing video content item, as an overlay on top of the video content item, or even on a separate device (for example a screen of a remote controller).
   The list of related items may change while watching a single media content item. As a movie's plot moves from one location to another, items in the list related to a previous location entity may be replaced or updated to reflect the new location entity. As a news item moves from interviewing one presidency candidate to interviewing his/her opponent, items in the list included for being related to the person being interviewed change from items related to the first candidate to items related to the second candidate.
C. When some related content is considered to be highly relevant to the identified entity, the system may decide not to wait for the user to express his wish to watch the related content by selecting it from the list of available options, but to automatically present it to the user once it is located. For example, when an identified entity is a real person entity and the related content is a still picture of that person, the system's policy (as set by the user or as set by the TV operator) may be to immediately display the picture on the screen, possibly accompanied by a textual title, without waiting for an explicit user request. The picture may be shown in a corner of the screen or as an overlay on top of the currently watched video content or side-by-side therewith.

As is easily seen, the proposed solution serves all the scenarios described hereinabove which are unserved by prior art methods and systems. Specifically the solution brings into play open-list entity identification and the proposing of dynamic connections of related content that is only determined in real-time after the media content item started playing. Additionally, the solution enables the provision of related content for short-lived entities, abstract entities, and entities which are implicit in the video content item even to passive users that prefer not to initiate interaction with the system or that are not responding fast enough to such short-lived entities.

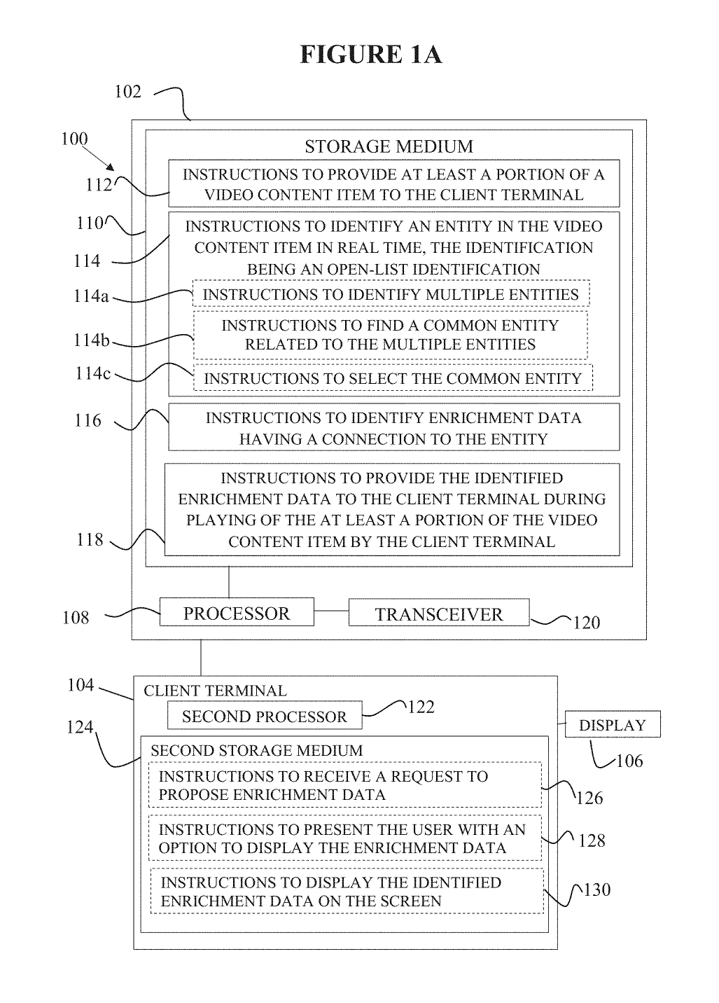

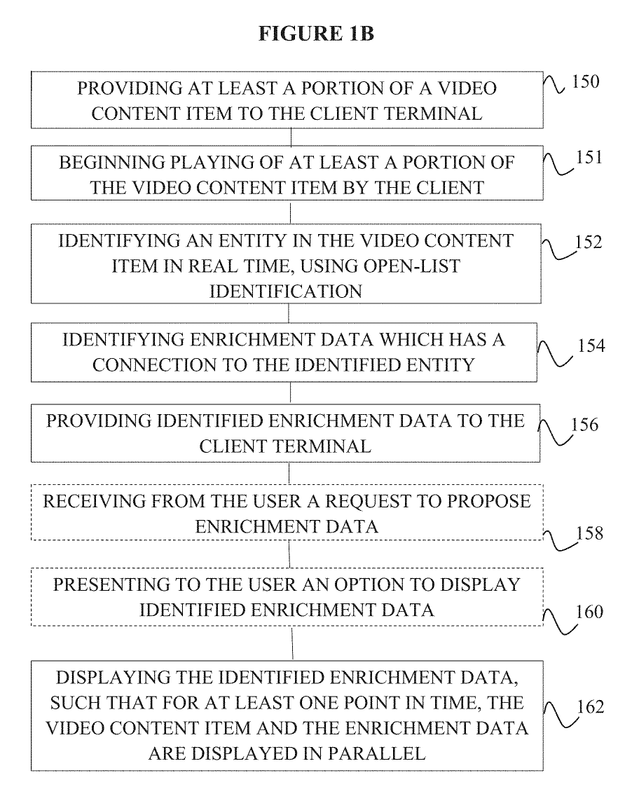

Reference is now made to FIGS. 1A and 1B, which are, respectively, a schematic block diagram of an embodiment of a system for enhancing user experience of a user watching video content and a flow chart of a method for enhancing user experience of a user watching video content, according to a first embodiment of the teachings herein. The system and method of FIGS. 1A and 1B are suitable for use with the “crime rate” example and with the “Golden State Warriors” example described hereinabove, as they enable open-list identification of entities.

As seen in FIG. 1A, a system 100 for providing enhancing a user experience of a user watching video content, includes a device 102, which in some embodiments forms part of a central server, and a client terminal 104, in communication with the device 102. The client terminal 104 includes or may be associated with a display 106, which may be a suitable display screen.

Device 102 includes a processor 108 and a storage medium 110, which is typically a non-transitory computer readable storage medium. The device 102 is adapted to provide to the client terminal 104 one or more video content items and/or enrichment data related to one or more entities identified in the video content item(s). In some embodiments, the device 102 is operated by a TV operator. In some embodiments, the device 102 is a Set-Top Box (STB) or other device receiving video content items from a central remote server and providing the video content items and related enrichment data to a client terminal or screen.

In some embodiments, the client terminal 104 is one of a TV set, a personal computer, a Set-Top-Box, a tablet, and a smartphone.

The storage medium 110 includes instructions to be executed by the processor 108, in order to carry out various steps of the method described herein below with respect to FIG. 1B. Specifically, the storage medium includes at least the following instructions:

instructions 112 to provide at least a portion of a video content item to the client terminal 104, thereby to enable playing the at least a portion of the video content item on the screen 106 of the client terminal 104:

instructions 114, to be carried out during playing of the at least a portion of the video content item, to identify an entity in the video content item in real-time, where the identification is an open-list identification;

instructions 116 to identify enrichment data having a connection to the identified entity; and

instructions 118 to provide the identified enrichment data to the client terminal 104 during the playing of the at least a portion of the video content item by the client terminal, thereby to enable displaying the identified enrichment data on the screen 106 of the client terminal 104.

In some embodiments, the instructions 114 include instructions to perform visual analysis of a video channel of the video content item. In some embodiments, the instructions 114 include instruction to perform aural analysis of the audio channel of the video content item. In some embodiments, the instructions 114 include:

instructions 114a to identify multiple entities in the at least a portion of the video content item;

instructions 114b to find a common entity, such as a group entity, that is related to each one of the multiple entities; and

instructions 114c to select the common entity as the identified entity.

For example, the instructions 114a. 114b, and 114c would be carried out in the “Golden State Warriors” example above, wherein each of the players would be identified as a person entity by carrying out of instructions 114a, and the common entity “Golden State Warriors” would be found by carrying out of instructions 114b.

In some embodiments, the instructions 116 include instructions to retrieve the enrichment data from the Internet and/or from a local storage device located in the vicinity of the client terminal 104.

In some embodiments, the instructions 116 are based on a location of the user, such as, for example, searching for enrichment data relating to crime rate in the city of the user, on a preference of the user, such as, for example searching for enrichment data relating to statistics of the state crime rate relative to other states for a user who is interested in statistics, and/or on at least one of current time of the day, current day of the week, current day of the month, a gender of the user and an age of the user, such as searching for textual enrichment data during weekdays and video enrichment data during weekends.

In some embodiments, processor 108 is connected to a network, such as the Internet, via a transceiver 120.

In some embodiments, the client terminal 104 includes a second processor 122, in communication with the device 102, and a second storage medium 124, which typically is a non-transitory computer readable storage medium. The second storage medium 124 includes instructions to be executed by the processor 122, in order to carry out various steps of the method described herein below with respect to FIG. 1B. Specifically, the second storage medium includes at least the following instructions:

instructions 126 to receive a request from the user to propose enrichment data that is connected to the video content item;

instructions 128 to present the user with an option to display the identified enrichment data, provided to the client terminal by the device 102; and

instructions 130 to display the identified enrichment data on screen 106 of client terminal 104, if the user had activated the option.

In some embodiments, the instructions 126 are carried out during playing of the video content item by the client terminal, when the user requests the enrichment data while the video content item is being played. In other embodiments, the enrichment data may be provided from device 102 to client terminal 104 irrespective of the user's request to propose such enrichment data.

In some embodiments, the instructions 128 are carried out subsequent to carrying out of instructions 126 and subsequent to the device 102 carrying out the instructions 116, or, stated differently, the option to display the identified enrichment data is displayed to the user subsequent to the user requesting that enrichment data be proposed and subsequent to receipt of an indication of the availability of relevant enrichment data from the device 102.

In some embodiments, the instructions 130 are carried out subsequent to the user activating the option presented to the user by carrying out of instructions 128.

In some embodiments, the instructions 126 may be obviated, and the instructions 128 to present the user with an option to display identified enrichment data may be carried out irrespective of the user requesting such enrichment data.

In some embodiments, the instructions 130 are carried out irrespective of the carrying out of instructions 128, and the identified enrichment data is displayed to the user on screen 106 regardless of the user activating an option to display such identified enrichment data. In some embodiments, the identified enrichment data is displayed on the screen 106 during playing of the video content item by terminal 104, for example side by side with the video content item, or as an overlay layer. In some embodiments, the identified enrichment data is displayed on screen 106 such that, for at least one point in time, the video content item and the identified enrichment data are displayed in parallel.

A method of using the system of FIG. 1A is now described with respect to FIG. 1B.

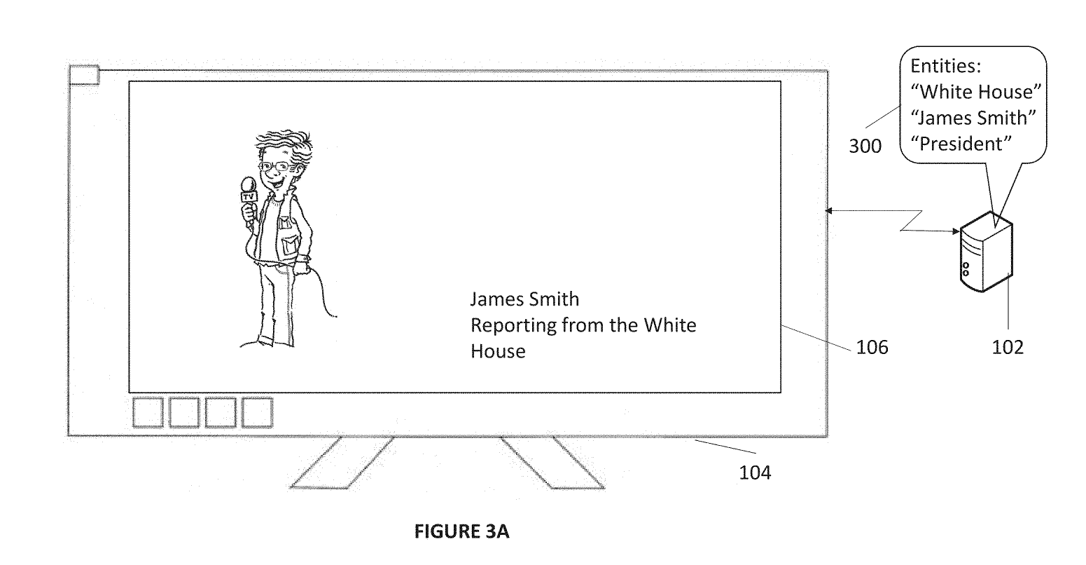

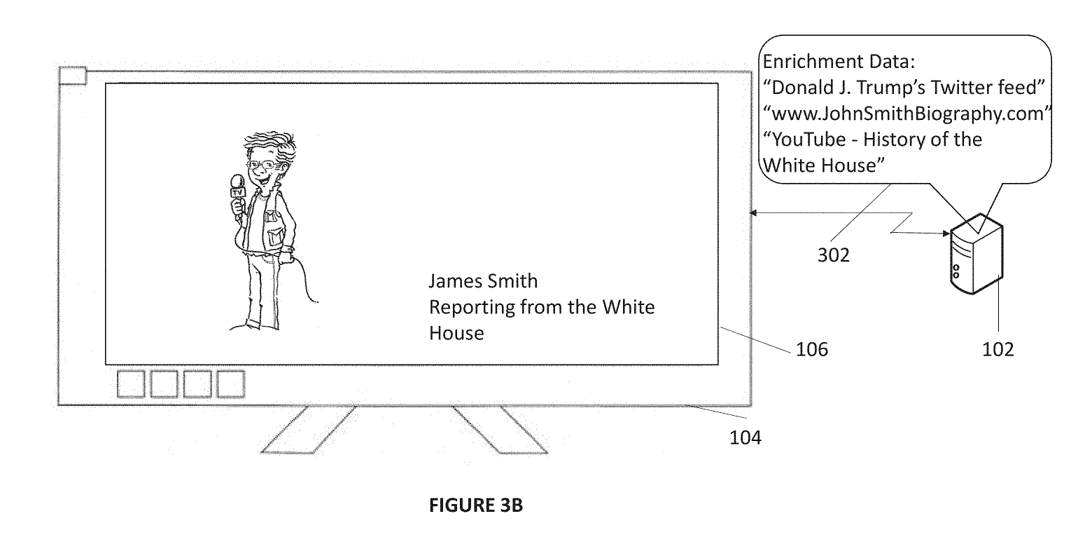

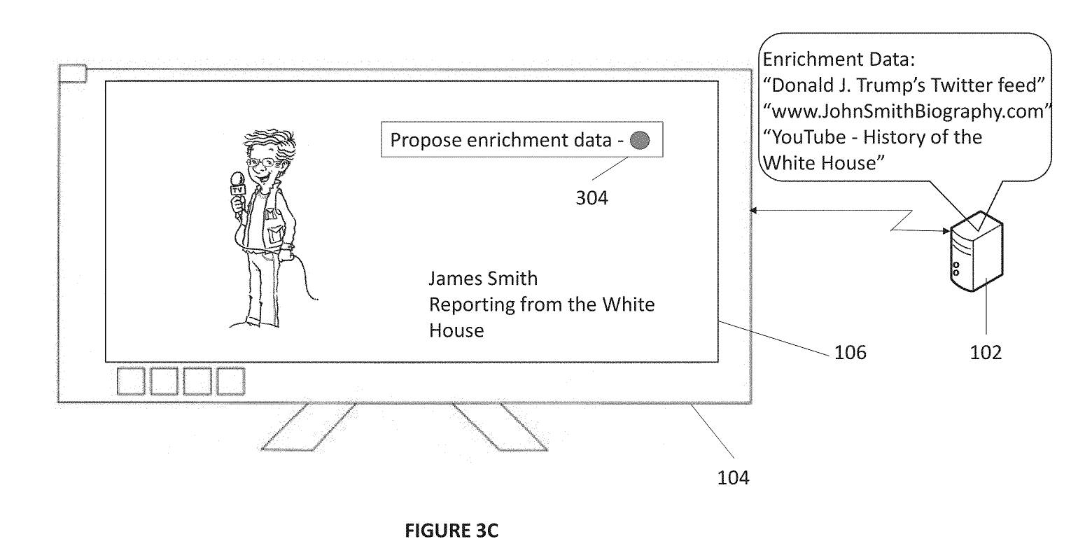

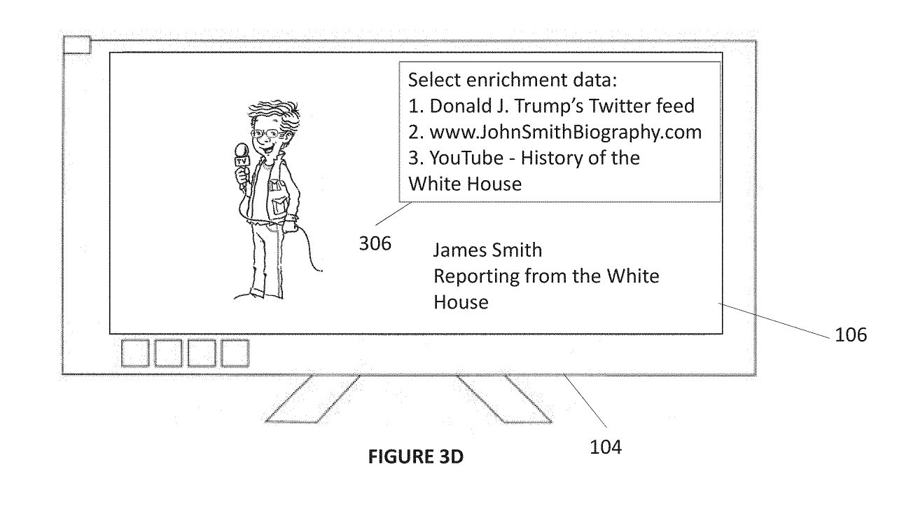

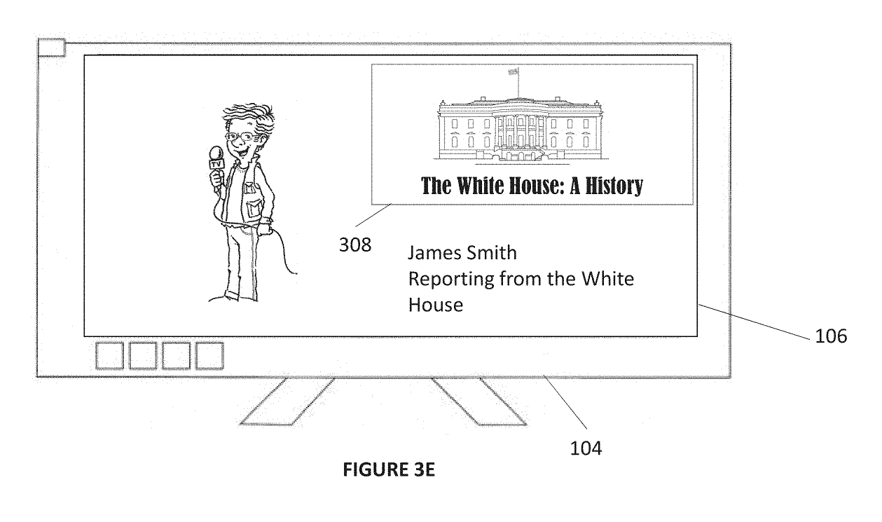

As seen, at step 150, at least a portion of a video content item is provided to the client terminal 104, executing instructions 112, and enabling the client terminal 104 to play the at least a portion of the video content item. The video content item, or the portion thereof, is provided to the client terminal by the device 102. For example, the video content item may be a news program, as described in the examples above, and as illustrated in FIG. 3A.

At step 151, the client terminal begins playing at least a portion of the video content item, received from device 102, on the screen 106.

At step 152, an entity is identified in the video content item in real-time using open-list identification, executing instructions 114. The identification of the entity is carried out in real-time, while the video content item, or the portion thereof, is playing on the screen 106 of the client terminal 104.

In some embodiments, step 152 includes performing a visual analysis of a video channel of the portion of the video content item. For example, the entity “Jerusalem street” may be identified if an image of a street in Jerusalem appears in the video channel of the video content item and a street sign with the logo of Jerusalem is visible. Similarly, in some embodiments, step 152 includes performing an aural analysis of an audio channel of the portion of the video content item. For example, the entity “Four Seasons” or “Vivaldi” may be identified if a segment of the piece “Four Seasons” by Vivaldi is played in the audio track of the video content item.

In some embodiments, open-list identification of entities in the video channel of the video content item may include carrying out the following steps:

1. Looking in the video channel of the video content item for any text appearing visually in the frames of the video channel, such as in signs, plaques, quotations, for example as appear when a news item or investigation program provides a transcription of a recording of a conversation, text shown in thought bubbles as often appears in cartoons and comics, documents shown in the video channel, and the like.
2. Each instance of such text, such as a street name appearing on a sign, a company name appearing on a sign or badge, a person's name appearing on a name plaque on a panel, a term appearing in quotations or in a document, and the like, is assumed to be a potential entity for which enrichment data is sought.

In some embodiments, the instances of text may be processed or filtered prior to assuming that they relate to entities, for example by removing words that are grammatical elements, such as the words “a”, “the”, “in”, and the like, or by removing text in foreign languages.

In some embodiments, open-list identification of entities in the audio channel of the video content item may include carrying out the following steps:

1. Looking in the audio channel of the video content item for all the spoken words, for example using speech-to-text technologies which are known in the art.
2. Removing from the resulting list of spoken words all the words included in a pre-defined dictionary, and defining each of the words remaining in the list of spoken words as an entity for which enrichment information should be sought.

In some embodiments, the pre-defined dictionary may include all the words in the language, such that the words remaining in the list of spoken words are names of people and/or places. In other embodiments, the pre-defined dictionary may include a subset of the words in the language.

In some embodiments, step 2 above may be repeated for pairs of words, or for longer groups of words, so as to facilitate identification of phrases or clauses, such as “crime rate” or “immigration policy”.

In some embodiments, the words extracted from the spoken text may be processed or filtered prior to assuming that they relate to entities, for example by removing words that are grammatical elements or by removing text in foreign languages.

It is appreciated that although a pre-defined list is used in the method disclosed herein, the list is used for excluding candidates from being identified as entities, not for identifying entities, and as such this method of identifying entities constitutes open-list identification as defined herein.

In some embodiments, the entity has an explicit appearance in the portion of the video content item. In some embodiments, the appearance of the entity is an explicit appearance of a name of the entity in an audio channel of the at least a portion of the video content item. For example, the video content item may be a news item relating to Hurricane Irma, in which the news anchor may mention the FEMA administrator Brock Long, in which case the system may identify “Brock Long” or “FEMA administrator” as the entity.

In some embodiments, the explicit appearance of the entity is an explicit appearance of a name of the entity in a video channel of the at least a portion of the video content item. For example, the video content item may show a political panel, in which each member has a plaque in front of them listing their name, such that the name of the entity explicitly appears in the video channel of the video content item.

In some embodiments, the explicit appearance of the entity is an explicit appearance of an image of the entity in a video channel of the at least a portion of the video content item. For example, the video content item may be a news item relating to Hurricane Irma, and may show an image of the Florida Keys, which may then be identified as the entity.

In some embodiments, the entity lacks an explicit appearance in the at least a portion of the video content item. For example, the video channel of a video content item may show an image of an earthworm, crawling in the soil underground. The system would identify the earthworm, and, knowing that earthworms are often associated with rain, when they come up to the surface, would identify the term “rain” as the entity, even though the rain was not shown in the video channel or mentioned in the audio channel of the video content item. As another example, the audio channel of a video content item may mention “Washington D.C.”, and the system may identify as entities specific landmarks located in “Washington D.C.”, such as the White House, the Capitol Building, the Smithsonian Institute, and the like, even though these are not explicitly shown or mentioned in the video content item.

In some embodiments, the entity is a generalized entity, which is identified by steps including identifying multiple entities in the at least a portion of the video content item, finding a common entity that is related to each one of the multiple entities, and selecting the common entity to be the identified entity. For example, as described in the example hereinabove, the faces or names of multiple players of the Golden State Warriors may initially be identified. The system may then recognize that all the identified entities belong to the Golden State Warriors, and thus identify “Golden State Warriors” as a separate and distinct entity.

In the example shown in FIG. 3A herein, the news program played on screen 106 shows a reporter, John Smith, providing commentary about the White House. As illustrated at reference numeral 300 of FIG. 3A, device 102 identifies the entities “the White House”, based on the text appearing on the screen, “James Smith”—the name of the reporter—based on recognition of his image and/or based on his name appearing on the screen, and “President”—implicitly identified due to identification of the White House.

At step 154, the device 102 executes instructions 116 and identifies enrichment data which has a connection to the identified entity. The enrichment data may be any suitable type of data such as audio data, video data, textual data, still images and the like. The enrichment data may be factual data relating to the entity, such as biographical information of a person entity, or geographical information of a location entity. The enrichment data may be buzz data relating to the entity, such as a tweet from a Twitter feed of a person entity, or a tweet mentioning a location entity.

In some embodiments, the enrichment data is retrieved from the Internet, and/or from a local storage device located in or in the vicinity of client terminal 104.

In some embodiments, identification of the enrichment data is based on the location of the user. As described above in the “crime rate” example, if the video content item is a news item relating to the crime rate in San Francisco, and the user is located in New York City, the system may search for enrichment data relating to the crime rate in New York City.

In some embodiments, identification of the enrichment data is based on preferences of the user, which may be pre-set by the user. For example, if the user indicates that he is interested in statistics, and the identified entity is “crime rate” as shown above, the system may search for statistics relating to crime rate in the last century, or statistics relating to the crime rate in different states or cities in the state.

In some embodiments, identification of the enrichment data is based on at least one of current time of the day, current day of the week, current day of the month, a gender of the user and an age of the user. Returning to the “crime rate” example, during the weekend the system may search for enrichment data relating to weekend crime rates or the change in crime rate during the weekend as compared to other weekdays.

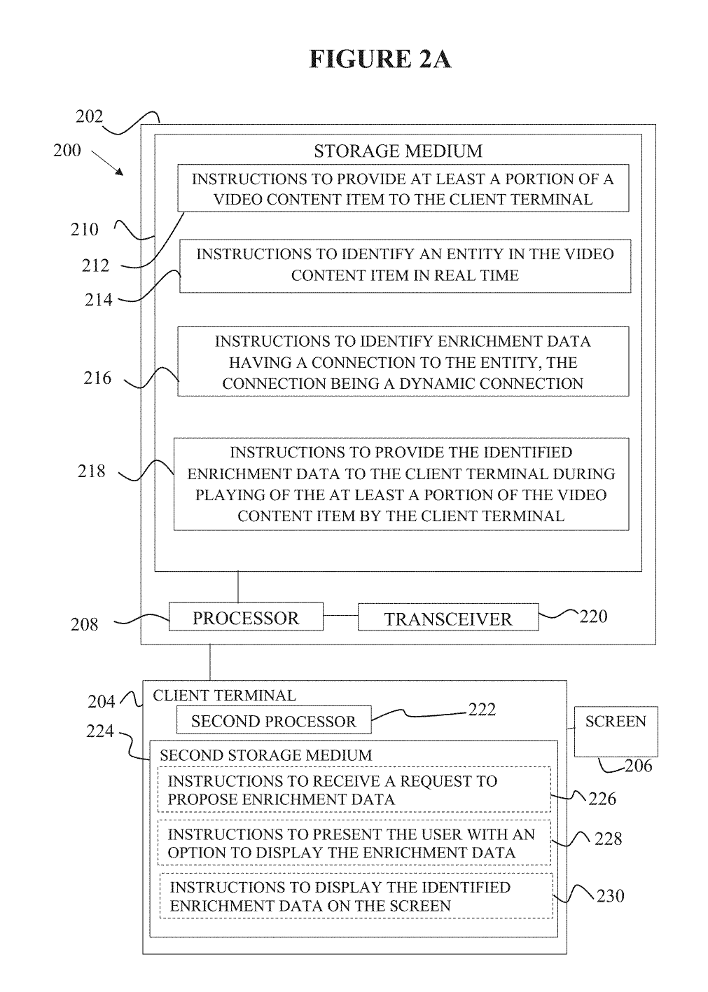

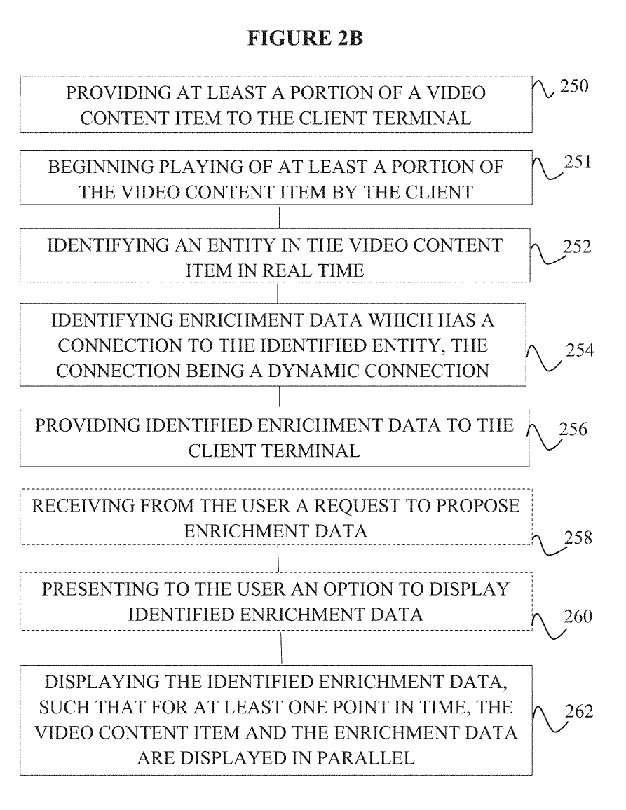

In some embodiments, the connection between the enrichment data and the entity is a dynamic connection, as described in further detail hereinbelow with reference to FIGS. 2A and 2B.

Returning to the example herein, the device 102 identifies enrichment data including Donald J. Trump's Twitter feed, which is related to the entity “President”, a website www.JohnSmithBiography.com” providing a biography of the reporter John Smith. and a YouTube documentary video showing the history of the White House and the people who lived there, as illustrated at reference numeral 302 in FIG. 3B.

At step 156, the device 102 executes instructions 118 and provides the identified enrichment data to client terminal 104, thereby enabling the client terminal 104 to display the identified enrichment data on screen 106.

In some embodiments, the method may further include step 158, in which the client terminal 104 executes instructions 126 and receives from the user a request to propose enrichment data that is connected to the video content item or to a portion thereof. Step 158 occurs following beginning of playing of the video content item at step 151, and while the video content item is playing.

For example, the user may press a button on his remote controller to request general enrichment data for the video content item, or may press the same button or a different button on his remote controller when a specific entity appears on the screen or is mentioned in the audio channel of the video content item, to request enrichment data relating to that specific entity.

In the example illustrated in FIG. 3C, the user requests enrichment data by pressing the blue circle button on his remote controller, as indicated at reference numeral 304.

However, it will be appreciated that the enrichment data may be identified by device 102 and may be provided thereby to the client terminal 104 irrespective of receipt of a corresponding user request. As such, in some embodiments, step 158 may be obviated.

In some embodiments, the method may further include step 160, in which the client terminal 104 executes instructions 128 and presents the user with an option to display the identified enrichment data. When step 158 takes place, step 160 occurs subsequent to step 158. Step 160 occurs following beginning of playing of the video content item at step 151 and while the video content item is playing, and following the client terminal 104 receiving the identified enrichment data from the device 102. For example, the screen 106 may present to the user a list of possible enrichment data items which the user may wish to view, or may present to the user a prompt indicating that the user should press a specific button on the remote controller to view enrichment data relating to the identified entity.

In some embodiments, when step 160 is executed, only names, descriptions or references of the identified enrichment data items (and not the full content of those items) are available in client terminal 104. Only when the user selects a specific item of enrichment data, is the selected specific item obtained by client terminal 104. In other embodiments, the complete content of the identified enrichment data items is obtained by client terminal 104 before presenting the option in step 160, so that the selected enrichment data item is immediately available to be presented upon selection by the user.

In the example illustrated in FIG. 3D, at reference numeral 306 the screen 106 presents the user with the enrichment data items previously provided by the device 102 (see FIG. 3B), and indicates that the user may select each of the presented enrichment data items by pressing the number associated with that data item.

In some embodiments, the method may further include step 162, in which the client terminal 104 executes instructions 130 and displays the identified enrichment data on screen 106. The enrichment data may be displayed alongside the video content item, in a PIP window overlaying a portion of the video content item, or the like.

In the example illustrated in FIG. 3E, at reference numeral 308 the selected enrichment data, here illustrated as a video relating to the history of the White House, is displayed to the user in a PIP window.

In some embodiments, in which step 160 takes place and the user is presented with an option to display the enrichment data, step 162 takes place subsequent to the user activating the option presented at step 160, for example by pressing the appropriate button on a remote controller or speaking a specific phrase identified by a speech recognition element of the client terminal.

In other embodiments, in which step 160 is obviated and the user is not presented with such an option, client terminal 104 automatically displays the enrichment data on the screen 106. The enrichment data is displayed such that for at least one point in time, and in some embodiments for the duration of display of the enrichment data, the at least a portion of the video content item and the enrichment data are displayed in a parallel.

Reference is now made to FIGS. 2A and 2B, which are, respectively, a schematic block diagram of an embodiment of a system for enhancing user experience of a user watching video content and a flow chart of a method for enhancing user experience of a user watching video content, according to a second embodiment of the teachings herein. The system and method of FIGS. 2A and 2B are suitable for use with the “car accident” example described hereinabove, as they relate to enrichment data having a dynamic connection to an identified entity.

As seen in FIG. 2A, a system 200 for providing enhancing a user experience of a user watching video content, includes a device 202, which in some embodiments forms part of a central server, and a client terminal 204, in communication with the device 202. The client terminal 204 includes or may be associated with a display 206, which may be a suitable display screen.

Device 202 includes a processor 208 and a storage medium 210, which is typically a non-transitory computer readable storage medium. The device 202 is adapted to provide to the client terminal 204 one or more video content items and/or enrichment data related to one or more entities identified in the video content item(s). In some embodiments, the device 202 is operated by a TV operator. In some embodiments, the device 202 is a Set-Top Box (STB) or other device receiving video content items from a central remote server and providing the video content items and related enrichment data to a client terminal or screen.

In some embodiments, the client terminal 204 is one of a TV set, a personal computer, a Set-Top-Box, a tablet, and a smartphone.

The storage medium 210 includes instructions to be executed by the processor 208, in order to carry out various steps of the method described herein below with respect to FIG. 2B. Specifically, the storage medium includes at least the following instructions:

instructions 212 to provide at least a portion of a video content item to the client terminal 204, thereby to enable playing the at least a portion of the video content item on the screen 206 of the client terminal 204:

instructions 214, to be carried out during playing of the at least a portion of the video content item, to identify an entity in the video content item in real-time;

instructions 216 to identify enrichment data having a connection to the identified entity, the connection being a dynamic connection; and

instructions 218 to provide the identified enrichment data to the client terminal 204 during the playing of the at least a portion of the video content item by the client terminal, thereby to enable displaying the identified enrichment data on the screen 206 of the client terminal 204.

In some embodiments, the instructions 214 include instructions to perform visual analysis of a video channel of the video content item. In some embodiments, the instructions 214 include instruction to perform aural analysis of the audio channel of the video content item.

In some embodiments, the instructions 216 include instructions to retrieve the enrichment data from the Internet and/or from a local storage device located in the vicinity of the client terminal 204.

In some embodiments, the instructions 216 are based on a location of the user, such as, for example, searching for enrichment data relating to crime rate in the city of the user, on a preference of the user, such as, for example searching for enrichment data relating to statistics of the state crime rate relative to other states for a user who is interested in statistics, and/or on at least one of current time of the day, current day of the week, current day of the month, a gender of the user and an age of the user, such as searching for textual enrichment data during weekdays and video enrichment data during weekends.

In some embodiments, processor 208 is connected to a network, such as the Internet, via a transceiver 220.

In some embodiments, the client terminal 204 includes a second processor 222, in communication with the device 202, and a second storage medium 224, which typically is a non-transitory computer readable storage medium. The second storage medium 224 includes instructions to be executed by the processor 222, in order to carry out various steps of the method described herein below with respect to FIG. 2B. Specifically, the second storage medium includes at least the following instructions:

instructions 226 to receive a request from the user to propose enrichment data that is connected to the video content item;

instructions 228 to present the user with an option to display the identified enrichment data, provided to the client terminal by the device 202; and

instructions 230 to display the identified enrichment data on screen 206 of client terminal 204, if the user had activated the option.

In some embodiments, the instructions 226 are carried out during playing of the video content item by the client terminal when the user requests the enrichment data while the video content item is being played. In other embodiments, the enrichment data may be provided from device 202 to client terminal 204 irrespective of the user's request to propose such enrichment data.

In some embodiments, the instructions 228 are carried out subsequent to carrying out of instructions 226 and subsequent to the device 202 carrying out the instructions 216, or, stated differently the option to display the identified enrichment data is displayed to the user subsequent to the user requesting that enrichment data be proposed and subsequent to receipt of an indication of the availability of relevant enrichment data from device 202.

In some embodiments, the instructions 230 are carried out subsequent to the user activating the option presented to the user by carrying out of instructions 228.

In some embodiments, the instructions 226 may be obviated, and the instructions 228 to present the user with an option to display identified enrichment data may be carried out irrespective of the user requesting such enrichment data.

In some embodiments, the instructions 230 are carried out irrespective of the carrying out of instructions 228, and the identified enrichment data is displayed to the user on screen 206 regardless of the user activating an option to display such identified enrichment data. In some embodiments, the identified enrichment data is displayed on the screen 206 during playing of the video content item by terminal 204, for example side by side with the video content item, or as an overlay layer. In some embodiments, the identified enrichment data is displayed on screen 206 such that, for at least one point in time, the video content item and the identified enrichment data are displayed in parallel.

A method of using the system of FIG. 2A is now described with respect to FIG. 2B.

As seen, at step 250, at least a portion of a video content item is provided to the client terminal 204, executing instructions 212, and enabling the client terminal 204 to play the at least a portion of the video content item. The video content item, or the portion thereof, is provided to the client terminal by the device 202. For example, the video content item may be a news program, as described in the examples above.

At step 251, the client terminal begins playing the at least a portion of the video content item, received from device 202, on the screen 206.

At step 252, instructions 214 are executed and an entity is identified in the video content item in real-time, while the video content item, or the portion thereof, is playing on the screen 206 of the client terminal 204.

In some embodiments, step 252 includes performing a visual analysis of a video channel of the portion of the video content item, and/or aural analysis of an audio channel of the portion of the video content item, substantially as described hereinabove with respect to step 152 of FIG. 1B.

In some embodiments, the entity has an explicit appearance in the portion of the video content item, such as an explicit appearance of a name of the entity in an audio channel of the at least a portion of the video content item, an explicit appearance of a name of the entity in a video channel of the at least a portion of the video content item, or an explicit appearance of an image of the entity in a video channel of the at least a portion of the video content item, substantially as described hereinabove with respect to step 152 of FIG. 1B.

In some embodiments, the entity lacks an explicit appearance in the at least a portion of the video content item, or is a generalized entity identified by initially identifying multiple entities and then finding a common entity that is related to each of the multiple entities, substantially as described hereinabove with respect to step 152 of FIG. 1B.

At step 254, the device 202 executes instructions 216 and identifies enrichment data which has a dynamic connection to the identified entity. In other words, the connection between the entity and the enrichment data did not exist prior to playing of the video content item, and in some cases, the enrichment data may not have existed at the beginning of playing the video content item.

Returning to the car accident example above, the video content item may be a news item relating to a recent fatal car accident, and the identified entity may then be “car accidents”. The enrichment data may relate to car accidents that occurred in a specific district in the last thirty minutes, which information would not have existed when the news broadcast had begun, 45 minutes prior to the news item.

As another example, a news item may relate to preparations in Florida for the arrival of “Hurricane Irma”, which is identified as the entity. The identified enrichment data may be a live video feed of Hurricane Irma impacting the Caribbean Islands or an updated count of the number of fatalities due to the hurricane.

The enrichment data may be any suitable type of data such as audio data, video data, textual data, still images and the like. The enrichment data may be factual data relating to the entity, such as biographical information of a person entity, or geographical information of a location entity. The enrichment data may be buzz data relating to the entity, such as a tweet from a Twitter feed of a person entity, or a tweet mentioning a location entity.

In some embodiments, the enrichment data is retrieved from the Internet, and/or from a local storage device located in or in the vicinity of client terminal 204.

In some embodiments, identification of the enrichment data is based on the location of the user, on preferences of the user, or on at least one of current time of the day, current day of the week, current day of the month, a gender of the user and an age of the user, substantially as described hereinabove with respect to step 154 of FIG. 1B.

At step 256, the device 202 executes instructions 218 and provides the identified enrichment data to client terminal 204, thereby enabling the client terminal 204 to display the identified enrichment data on screen 206.

In some embodiments, the method may further include step 258, in which the client terminal 204 executes instructions 226 and receives from the user a request to propose enrichment data that is connected to the video content item or to a portion thereof. Step 258 occurs following beginning of playing of the video content item at step 251 and during playing of the video content item, substantially as described hereinabove with respect to step 158 of FIG. 1B.

In some embodiments, the method may further include step 260, in which the client terminal 204 executes instructions 228 and presents the user with an option to display the identified enrichment data. As discussed hereinabove with respect to step 160 of FIG. 1B, when step 258 takes place, step 260 occurs subsequent to step 258. Step 260 occurs following beginning of playing of the video content item at step 251 and during playing of the video content item, and following the client terminal 204 receiving the identified enrichment data from the device 202.

In some embodiments, when step 260 is executed, only names, descriptions or references of the identified enrichment data items (and not the full content of those items) are available in client terminal 204. Only when the user selects a specific item of enrichment data, is the selected specific item obtained by client terminal 204. In other embodiments, the complete content of the identified enrichment data items is obtained by client terminal 204 before presenting the option in step 260, so that the selected enrichment data item is immediately available to be presented upon selection by the user.

In some embodiments, the method may further include step 262, in which the client terminal 204 executes instructions 230 and displays the identified enrichment data on screen 206. The enrichment data may be displayed alongside the video content item, in a PIP window overlaying a portion of the video content item, or the like.

As discussed hereinabove with respect to step 162 of FIG. 1B, in some embodiments, in which step 260 takes place and the user is presented with an option to display the enrichment data, step 262 takes place subsequent to the user activating the option presented at step 260. In other embodiments, in which step 260 is obviated and the user is not presented with such an option, client terminal 204 automatically displays the enrichment data on the screen 206, such that for at least one point in time, and in some embodiments for the duration of display of the enrichment data, the at least a portion of the video content item and the enrichment data are displayed in a parallel.

FIGS. 3A-3E, which were explained above in the context of the first embodiment, are also applicable for explaining the interaction between the client terminal 204 and the user in the second embodiment. Obviously, when applying those figures to the second embodiment, the selected enrichment data item displayed in FIG. 3E has a dynamic connection to the video content item. For example, the selected enrichment data item may be video footage from a press conference held by the President in the White House after the video content item started playing.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A method for enhancing user experience of a user watching video content on a screen of a client terminal, the method comprising:
a. providing at least a portion of a video content item to the client terminal, thereby enabling playing the at least a portion of the video content item on the screen of the client terminal;
b. during the playing of the at least a portion of the video content item, identifying an entity in the video content item in real-time, wherein the identification is an open-list identification;
c. identifying enrichment data having a connection to the entity;
d. providing the identified enrichment data to the client terminal during the playing of the at least a portion of the video content item by the client terminal, thereby enabling displaying the identified enrichment data on the screen of the client terminal.

2. The method of claim 1, wherein the identifying of the entity comprises performing a visual analysis of a video channel of the at least a portion of the video content item.

3. The method of claim 1, wherein the identifying of the entity comprises performing aural analysis of an audio channel of the at least a portion of the video content item.

4. The method of claim 1, wherein the identifying of the entity comprises:
a. identifying multiple entities in the at least a portion of the video content item;
b. finding a common entity that is related to each one of the multiple entities; and
c. selecting the common entity to be the identified entity.

5. The method of claim 1, further comprising:
e. during the playing of the at least a portion of the video content item by the client terminal, receiving a request from the user to propose enrichment data that is connected to the at least a portion of the video content item;
f. subsequent to the receiving of the request and subsequent to the providing of the identified enrichment data to the client terminal, presenting the user with an option to display the identified enrichment data; and
g. subsequent to the user activating the option, displaying the identified enrichment data on the screen of the client terminal.

6. The method of claim 1, further comprising:
e. during the playing of the at least a portion of the video content item by the client terminal, presenting the user with an option to display the identified enrichment data; and
f. subsequent to the user activating the option, displaying the identified enrichment data on the screen of the client terminal.

7. The method of claim 1, wherein the identifying of the enrichment data is based on at least one of current time of the day, current day of the week, current day of the month, a gender of the user and an age of the user.

8. A method for enhancing user experience of a user watching video content on a screen of a client terminal, the method comprising:
a. providing at least a portion of a video content item to the client terminal, thereby enabling playing of the at least a portion of the content item on the screen of the client terminal;
b. during the playing of the at least a portion of the video content item, identifying an entity in the video content item in real-time;
c. identifying enrichment data having a connection to the entity, wherein the connection between the enrichment data and between the entity is a dynamic connection; and
d. providing the identified enrichment data to the client terminal during the playing of the at least a portion of the video content item by the client terminal, thereby enabling displaying the identified enrichment data on the screen of the client terminal.

9. The method of claim 8, wherein the identified enrichment data is created during the playing of the at least a portion of the video content item by the client terminal.

10. The method of claim 8, wherein the identifying of the enrichment data is based on at least one of current time of the day, current day of the week, current day of the month, a gender of the user and an age of the user.

11. The method of claim 8, wherein the identifying of the entity comprises performing a visual analysis of a video channel of the at least a portion of the video content item.

12. The method of claim 8, wherein the identifying of the entity comprises performing aural analysis of an audio channel of the at least a portion of the video content item.

13. The method of claim 8, wherein the entity has an explicit appearance in the at least a portion of the video content item.

14. The method of claim 13, wherein the explicit appearance of the entity is an explicit appearance of a name of the entity in an audio channel of the at least a portion of the video content item.

15. The method of claim 13, wherein the explicit appearance of the entity is an explicit appearance of a name of the entity in a video channel of the at least a portion of the video content item.

16. The method of claim 8, wherein the identifying of the entity comprises:
a identifying multiple entities in the at least a portion of the video content item;
b. finding a common entity that is related to each one of the multiple entities; and
c. selecting the common entity to be the identified entity.

17. The method of claim 8, further comprising:
e. during the playing of the at least a portion of the video content item by the client terminal, receiving a request from the user to propose enrichment data that is connected to the at least a portion of the video content item;
f. subsequent to the receiving of the request and subsequent to the providing of the identified enrichment data to the client terminal, presenting the user with an option to display the identified enrichment data; and
g. subsequent to the user activating the option, displaying the identified enrichment data on the screen of the client terminal.

18. The method of claim 8, further comprising:
e. during the playing of the at least a portion of the video content item by the client terminal, presenting the user with an option to display the identified enrichment data; and
f. subsequent to the user activating the option, displaying the identified enrichment data on the screen of the client terminal.

19. A device for enhancing user experience of a user watching video content on a screen of a client terminal, the device comprising:
a. a processor in communication with the client terminal; and
b. a non-transitory computer readable storage medium for instructions execution by the processor, the non-transitory computer readable storage medium having stored:
i. instructions to provide at least a portion of a video content item to the client terminal, thereby to enable playing the at least a portion of the video content item on the screen of the client terminal;
ii. instructions, to be carried out during the playing of the at least a portion of the video content item, to identify an entity in the video content item in real-time, wherein the identification is an open-list identification;
iii. instructions to identify enrichment data having a connection to the entity; and
iv. instructions to provide the identified enrichment data to the client terminal during the playing of the at least a portion of the video content item by the client terminal, thereby to enable displaying the identified enrichment data on the screen of the client terminal.

20. A device for enhancing user experience of a user watching video content on a screen of a client terminal, the device comprising:
a. a processor in communication with the client terminal; and
b. a non-transitory computer readable storage medium for instructions execution by the processor, the non-transitory computer readable storage medium having stored:
i. instructions to provide at least a portion of a video content item to the client terminal, thereby to enable playing the at least a portion of the video content item on the screen of the client terminal;
ii. instructions, to be carried out during the playing of the at least a portion of the video content item, to identify an entity in the video content item in real-time;
iii. instructions to identify enrichment data having a connection to the entity, wherein the connection between the enrichment data and between the entity is a dynamic connection; and
iv. instructions to provide the identified enrichment data to the client terminal during the playing of the at least a portion of the video content item by the client terminal, thereby to enable displaying the identified enrichment data on the screen of the client terminal.
